(19) United States
(12) Patent Application Publication
(10) Pub. No.: US 2004/0151659 A1
(43) Pub. Date: Aug. 5, 2004

(54) Direct synthesis of hydrogen peroxide in a multicomponent solvent system

(76) Inventors: Giuseppe Paparatto, Balsamo-Milan (IT); Giordano De Alberti, Besnate-Varese (IT); Rino D'Aloisio, Novara (IT)

Correspondence Address: Oblon Spivak McClelland, Maier & Neustadt, Fourth Floor, 1755 Jefferson Davis Highway, Arlington, VA, 22202, US

(21) Appl. No.: 10/476,498

(22) PCT Filed: Apr. 25, 2002
(86) PCT No.: PCT/EP02/04578

(30) Foreign Application Priority Data
May 17, 2001 (IT) MI2001A001015

(51) Int. Cl. C01B 15/029

(52) U.S. Cl. 423/584

(57) ABSTRACT

A process is described for the production of hydrogen peroxide from hydrogen and oxygen in a reaction solvent containing a halogenated promoter and/or an acid promoter, in the presence of a heterogeneous catalyst based on one or more metals of the platinum group, wherein the reaction solvent consists of: (1) an alcohol or mixture of alcohols; (2) one or more C₅-C₃₂ hydrocarbons; and (3) optionally water. The process operates under high safety conditions with a high productivity and molar selectivity towards the formation of H₂O₂.

The present invention relates to a process for the production of hydrogen peroxide (H₂O₂) from hydrogen and oxygen which uses as reaction solvent, a mixture consisting of one or more alcohols, at least one C₅-C₃₂ hydrocarbon and optionally water.

Hydrogen peroxide is a commercially important product which is widely used as a bleach in the textile and paper industry, as biocide in the environmental field and in the chemical industry in oxidation processes.

Examples of these oxidation processes are those using titanium silicalite as catalysts, such as the epoxidation of olefins (EP-100,119), the ammoximation of carbonyl compounds (U.S. Pat. No. 4,794,198), the oxidation of ammonia to hydroxylamine (U.S. Pat. No. 5,320,819) and the hydroxylation of aromatic hydrocarbons (U.S. Pat. No. 4,369,783).

The industrial production of aqueous solutions of H₂O₂ by means of a complex two-step process, is known.

In this process a solution of an anthraquinone, such as butylanthraquinone or ethylanthraquinone, in an organic medium immiscible with water, is first hydrogenated and then oxidized with air to produce H₂O₂ which is subsequently extracted in aqueous phase.

This process, however, has considerable disadvantages deriving from the necessity of operating with large volumes of reagents, the numerous steps required, the relatively high cost of the intermediates and production of inactive by-products.

Processes for the direct synthesis of hydrogen peroxide from H₂ and O₂ have been studied, to overcome these drawbacks. These processes are generally carried out by reacting the two gases in a solvent consisting of an aqueous medium or an aqueous-organic medium, in the presence of a catalytic system consisting of a noble metal, particularly metals of the platinum group or their mixtures, in the form of salts or as supported metals.

Among processes of this type, those which seem particularly attractive from a technical and economic point of view, operate in an alcohol or alcohol-aqueous medium, for example, in methanol or in methanol-water described, for example, in U.S. Pat. No. 4,335,092, in patent application WO 98/16463, in European patent application EP 787681 and more specifically in European patent application EP 978316 and in Italian patent applications MI 2000 A001218, MI 2000 A001219 and MI 2000 A001881.

In fact, with the other conditions remaining unchanged, higher reaction rates and selectivities are observed with respect to operating in an aqueous medium.

The high reaction performances result, in turn:

i. in the possibility of carrying out the process under high safety conditions, well outside the explosivity zone of H₂—O₂ mixtures, without jeopardizing the process from a technical-economic point of view;

ii. in the possibility of using extremely low quantities of promoters (halides and acids) in the reaction medium, with beneficial effects on the stability of the catalytic system and on the production of stable hydrogen peroxide solutions, at a concentration suitable for direct use and economically valid in oxidation processes.

Furthermore, the problem relating to the formation of organic peroxides is minimized with respect to processes which operate in the presence of other organic solvents, such as acetone, for example.

Finally, the concentration of the hydrogen peroxide produced, can reach commercially useful values, as the boiling point and the evaporation heat of the alcohol, suitably selected, are lower than those of water.

It has now been found that it is possible to further improve these processes, in terms of selectivity and from an economic point of view, by using, as reaction solvent, a system comprising one or more alcohols, at least a C₅-C₃₂ hydrocarbon and optionally water.

The H₂O₂ solutions obtained can be used directly in oxidation processes which use titanium silicalite as catalyst, as the components of the solvent mixture are compatible with said processes.

In accordance with this, an object of the present invention relates to a process for the production of hydrogen peroxide starting from hydrogen and oxygen, in a reaction solvent containing a halogenated promoter and/or an acid promoter, in the presence of a heterogeneous catalyst based on one or more metals of the platinum group, wherein the reaction solvent consists of:

(1) an alcohol or mixture of alcohols;

(2) one or more C₅-C₃₂ hydrocarbons; and

(3) optionally water.

Examples of alcohols suitable for the purposes of the present invention are selected from those having from 1 to 6, preferably from 1 to 4, carbon atoms.

Among C₁-C₄ alcohols, methanol, ethanol, terbutanol (TBA) or their mixtures, are preferred. Methanol is particularly preferred.

The quantity of alcohol or mixture of alcohols ranges from 10 to 99.9% by weight with respect to the solvent mixture, preferably from 20 to 80% by weight with respect to the reaction solvent.

The C₅-C₃₂ hydrocarbons are generally selected from paraffins, cyclo-paraffins or aromatic compounds.

The paraffinic hydrocarbons are preferably selected from those having from 5 to 18, carbon atoms, and can be linear or branched.

Examples of said paraffinic hydrocarbons are n-hexane, n-heptane, n-octane, n-decane or their branched isomers.

Examples of cyclo-paraffinic hydrocarbons are cyclohexane, decaline or their derivatives substituted with one or more alkyl groups having from 1 to 6 carbon atoms. Typical examples of said compounds are methyl-cyclohexane, ethyl-cyclohexane or dimethyl-cyclohexane.

Aromatic hydrocarbons suitable for the purposes of the present invention are preferably selected from those having from 6 to 24 carbon atoms.

Examples of aromatic hydrocarbons are benzene, naphthalene, alkylbenzenes and alkylnaphthalenes with one or more linear or branched alkyl chains, having from 1 to 18, preferably from 6 to 12, carbon atoms. Examples of alkylbenzenes are toluene, xylenes (ortho, meta and para), ethylbenzene and cumene.

The quantity of hydrocarbons which is used in the reaction is in relation to the type of alcohol(s) used, and generally ranges from 0.01 to 40% by weight, preferably from 0.1 to 20% by weight, with respect to the total reaction mixture.

The quantity of water, when present, ranges from 0 to 50% by weight with respect to the reaction solvent, preferably from 2 to 30% by weight with respect to the reaction solvent.

The catalyst which can be used for the purposes of the invention is a heterogeneous catalyst containing one or more metals of the platinum group as active components. Examples of these metals are palladium, platinum, ruthenium, rhodium, iridium and gold. Preferred metals are palladium and platinum.

The palladium is normally present in these catalysts in a quantity ranging from 0.1 to 5% by weight and the platinum in a quantity ranging from 0.01 to 1% by weight, with an atomic ratio between platinum and palladium ranging from 0.1/99.9 to 50/50.

The palladium is preferably present in a quantity ranging from 0.2 to 3% by weight and the platinum in a quantity ranging from 0.02 to 0.5% by weight, with an atomic ratio between platinum and palladium ranging from 1/99 to 30/70.

In addition to palladium and platinum, other metals of group VIII or IB, such as, for example, ruthenium, rhodium, iridium and gold, can be present as active components or promoters, in a concentration generally not higher than that of the palladium.

The catalyst can be prepared by dispersing the active components on an inert carrier by means of precipitation and/or impregnation starting from precursors consisting, for example, of solutions of their salts or soluble complexes, and therein reduced to the metal state by means of thermal and/or chemical treatment with reducing substances such as hydrogen, sodium formiate, sodium citrate by means of preparative techniques well known in the state of the art.

According to an embodiment of the present invention, the catalyst can be prepared by dispersing in sequence and alternating the precursors of the single metal components of the catalyst on a carrier, as described and claimed in the patent application IT MI2000-A001219.

The inert carrier may typically consist of activated carbon, silica, alumina, silica-alumina, zeolites, and other materials well known in the state of the art. Activated carbon is preferred for the preparation of the catalysts useful for the invention.

Activated carbons which can be used for the invention are selected from those of fossil or natural origin deriving for example from wood, lignite, peat or coconut and having a surface area higher than 100 m²/g, preferably higher than 300 m²/g; a carbon with a surface area higher than 600 m²/g is particularly preferred. Preferred activated carbons are those with a low ash content.

The sulfonated activated carbons described in European patent application EP 978316 can be used for the purpose.

Before the supporting or impregnation of the metals, the activated carbon can be subjected to treatment such as washing with distilled water or treatment with acids, bases or diluted oxidizing agents, for example acetic acid, hydrochloric acid, sodium carbonate and hydrogen peroxide.

The catalyst is normally dispersed in the reaction medium at a concentration ranging from 0.1 to 10% by weight, preferably from 0.3 to 3% by weight with respect to the reaction solvent.

The acid promoter may be any substance capable of generating H⁺ hydrogen ions in the reaction solvent and is generally selected from inorganic acids such as sulfuric, phosphoric, nitric acid or from organic acids such as sulfonic acids. Sulfuric acid and phosphoric acid are preferred. The concentration of the acid generally ranges from 20 to 1000 mg per kg of reaction solvent and preferably from 50 to 500 mg per kg of reaction solvent.

The halogenated promoter can be any substance capable of generating halide ions in the reaction solvent. Substances capable of generating bromide ions are preferred. These substances are generally selected from hydrobromic acid and its salts soluble in the reaction medium, for example sodium bromide, potassium bromide, sodium bromate or ammonium bromide. Hydrobromic acid, sodium bromide and potassium bromide are preferred.

The concentration of the halogenated promoter generally ranges from 0.1 to 50 mg per kg of reaction solvent and preferably from 1 to 10 mg per kg of reaction solvent.

The production of hydrogen peroxide is carried out by reacting oxygen and hydrogen in the reaction solvent in the presence of the catalyst and promoters and in the presence or absence of an inert gas selected from nitrogen, helium, argon. Nitrogen is the preferred gas.

The molar ratio H₂/O₂ in the feeding ranges from 1/1 to 1/100, preferably from 1/2 to 1/15 and the concentration of hydrogen in the gaseous phase in contact with the liquid reaction medium is conveniently maintained at a value lower than 4.5% molar, outside the explosivity limits of the mixture consisting of H₂, O₂ and, optionally, an inert gas.

According to an embodiment of the process of the present invention, the reaction can be carried out using air instead of pure oxygen.

The reaction is typically carried out at temperatures ranging from −5° to 90° C., preferably from 2 to 50° C. and at a total pressure higher than atmospheric pressure, preferably ranging from 30 to 300 bars.

The process according to the present invention can be carried out batchwise or, preferably, in continuous using a reactor suitable for the purpose and selected from those described in the state of the art.

Operating under the above conditions, it is possible to produce hydrogen peroxide under safety conditions with a reaction productivity normally ranging from 30 to 200 g of H₂O₂ (expressed as H₂O₂ at 100%) per litre of reaction medium per hour and with a molar selectivity towards the formation of H₂O₂, referring to the hydrogen used up, ranging from 60% to 90%.

The solutions of hydrogen peroxide thus obtained can be used directly in oxidation processes which comprise the use of H₂O₂ without complex intermediate processing such as the removal of acids and solvents.

Furthermore, the process of the present invention is suitable for the production of aqueous solutions of H₂O₂ for commercial use, by the removal of the organic components from the reaction medium, for example by distillation, which can be recycled to the synthesis.

The process of the present invention allows the reagents to be transformed into H₂O₂ with high conversions and selectivities, obtaining H₂O₂ solutions without acidity or containing only traces of acidity and/or salts.

The following examples, which have the sole purpose of describing the present invention in greater detail, should in no way be considered as limiting its scope.

### EXAMPLE 1

Treatment of the Carrier

50 g of activated carbon in maritime pine charcoal in powder form (CECA) and 500 ml of distilled water are charged into a 1 liter glass flask. After 2 hours at 80° C., the activated carbon is filtered and washed with 500 ml of distilled water.

The activated carbon, still damp, is then charged into the 1 liter flask and after adding 500 ml of a solution at 2% by weight of HCl, the temperature is brought to 80° C. After about 2 hours, the mixture is cooled and the activated carbon is washed on a filter with distilled H₂O until the chlorides have been eliminated. The washed activated carbon is recovered and dried in an oven at 120° C. for 2 hours.

### EXAMPLE 2

Preparation of the Catalyst 1% Pd-0.1% Pt/C

10 g of activated carbon treated as described in example 1, are charged into a 0.5 liter glass flask, containing 100 ml of distilled water and 0.32 g of Na₂CO₃. The suspension is maintained at room temperature (20-25° C.), under stirring, for 10 minutes.

10 ml of an aqueous solution containing 1.0 g of a solution of Na₂PdCl₄ at 10% by weight of Pd and 0.1 g of a solution of H₂PtCl₆ at 10% by weight, are subsequently added dropwise over a period of about 10 minutes.

The suspension is kept at room temperature for 10 minutes and is then heated for 10 minutes to 90° C. A solution containing 0.85 g of sodium formiate in 10 ml of water is then added and the stirring is continued at 90° C. for 2 hours.

After cooling to room temperature, the suspension is filtered and the catalyst recovered is washed with distilled water until the chlorides have been eliminated and dried in an oven at 120° C. for 2 hours.

### EXAMPLE 3 (COMPARATIVE)

Synthesis of Hydrogen Peroxide

A micropilot plant is used, consisting of a Hastelloy C autoclave having a volume of 350 ml, equipped with a thermostat-regulation system, a magnetic drag stirring system, a regulation and control system of the pressure during the reaction, a filter for continuously removing the liquid phase containing the reaction products, a feeding system of the mixture of solvent and promoters in which the reaction takes place, a feeding system of the gaseous reagents and a series of regulation and control instruments.

0.6 g of catalyst prepared as described in example 1 and 100 g of methanol:water solution (97/3 by weight) containing 6 ppm of HBr and 200 ppm of H₂SO₄ are charged into the reactor.

The autoclave is pressurized, without stirring, at 100 bars with a gaseous mixture consisting of 3.6% of H₂, 11% of O₂ and 85.4% of N₂ by volume. The stirring is then started up to 800 revs/minute, the pressure is maintained with a continuous stream, 700 normal liters (Nl/hour), of the same gaseous mixture, with the contemporaneous feeding of 300 g/hour of a methanol:water solution having the composition defined above and containing 6 ppm of HBr and 200 ppm of H₂SO₄. The temperature inside the reactor is kept at 6° C. The reaction trend is followed by continuously analyzing the hydrogen and oxygen in the feeding and at the outlet of the reactor.

The concentration of H₂O₂ which is formed is determined in the reactor liquid effluent by titration with potassium permanganate. The selectivity with respect to the converted hydrogen is calculated on the basis of the concentration of H₂O₂ in the reaction effluent and on the basis of analysis of the H₂ leaving the reactor, once the stationary state has been reached in the reactor.

The results obtained are indicated in Table 1.

### EXAMPLE 4

Example 3 was repeated, feeding to the reactor a liquid mixture consisting of 96% of methanol, 1% of cyclohexane and 3% of water (methanol/water weight ratio=32) and containing 6 ppm of HBr and 200 ppm of H₂SO₄. The results are indicated in Table 1.

### EXAMPLE 5

Example 3 was repeated, feeding to the reactor a liquid mixture consisting of 94% of methanol, 3% of cyclohexane and 3% of water (methanol/water weight ratio=31.3) and containing 6 ppm of HBr and 200 ppm of H₂SO₄. The results are indicated in Table 1.

### EXAMPLE 6

Example 3 was repeated, feeding to the reactor a liquid mixture consisting of 92% of methanol, 5% of cyclohexane and 3% of water (methanol/water weight ratio=30.7) and containing 6 ppm of HBr and 200 ppm of H₂SO₄. The results are indicated in Table 1.

### EXAMPLE 7

Example 3 was repeated, feeding to the reactor a liquid mixture consisting of 94% of methanol, 3% of n-hexane and 3% of water (methanol/water weight ratio=31.3) and containing 6 ppm of HBr and 200 ppm of H₂SO₄.

The results are indicated in Table 1.

TABLE 1

| Ex. | Reaction | Paraffin/Cyclo- | H₂O₂ | H₂O₂ Selectivity |
|---|---|---|---|---|
| Nr. | hours | paraffin % | wt % | molar % |
| 3 | 65 | 0 | 5.96 | 76 |
| 4 | 65 | 1% cyclohexane | 5.71 | 87 |
| 5 | 65 | 3% cyclohexane | 5.5 | 89 |
| 6 | 65 | 5% cyclohexane | 5.5 | 89 |
| 7 | 65 | 3% n-hexane | 5.2 | 85 |

1. A process for the production of hydrogen peroxide from hydrogen and oxygen in a reaction solvent containing a halogenated promoter and/or an acid promoter, in the presence of a heterogeneous catalyst based on one or more metals of the platinum group, wherein the reaction solvent consists of:
(1) an alcohol or mixture of alcohols;
(2) one or more C₅-C₃₂ hydrocarbons; and
(3) optionally water.

2. The process according to claim 1, wherein the alcohol is selected from those having from 1 to 6 carbon atoms.

3. The process according to claim 2, wherein the alcohol is selected from those having from 1 to 4 carbon atoms.

4. The process according to claim 3, wherein the alcohol is selected from methanol, ethanol, terbutanol (TBA) or their mixtures.

5. The process according to claim 4, wherein the alcohol is methanol.

6. The process according to claim 1, wherein the quantity of alcohol or mixture of alcohols ranges from 10 to 99.9% by weight with respect to the reaction solvent.

7. The process according to claim 6, wherein the quantity of alcohol or mixture of alcohols ranges from 20 to 80% by weight with respect to the reaction solvent.

8. The process according to claim 1, wherein the C₅-C₃₂ hydrocarbons are selected from paraffins, cyclo-paraffins and aromatic compounds.

9. The process according to claim 8, wherein the paraffins are selected from those having from 5 to 18 carbon atoms and can be linear or branched.

10. The process according to claim 9, wherein the paraffins are selected from n-hexane, n-heptane, n-octane, n-decane or their branched isomers.

11. The process according to claim 8, wherein the cyclo-paraffins are selected from cyclohexane, decaline or their derivatives substituted with one or more alkyl groups having from 1 to 6 carbon atoms.

12. The process according to claim 11, wherein the substituted cyclo-paraffins are selected from methyl-cyclohexane, ethyl-cyclohexane and dimethyl-cyclohe-xane.

13. The process according to claim 8, wherein the aromatic hydrocarbons are selected from those having from 6 to 24 carbon atoms.

14. The process according to claim 13, wherein the aromatic hydrocarbons are selected from benzene, naphthalene, alkylbenzenes and alkylnaphthalenes with one or more linear or branched alkyl chains having from 2 to 18 carbon atoms.

15. The process according to claim 14, wherein the linear or branched alkyl chain has from 6 to 12 carbon atoms.

16. The process according to claim 13, wherein the alkylbenzenes are selected from toluene, xylenes (ortho, meta and para), ethylbenzene and cumene.

17. The process according to claim 1, wherein the quantity of hydrocarbons ranges from 0.01 to 40% by weight with respect to the reaction solvent.

18. The process according to claim 17, wherein the quantity of hydrocarbons ranges from 0.1 to 20% by weight with respect to the reaction solvent.

19. The process according to claim 1, wherein the metal components of the catalyst are selected from palladium, platinum, ruthenium, rhodium, iridium and gold.

20. The process according to claim 19, wherein the metal components of the catalyst are palladium and platinum.

21. The process according to claim 20, wherein the catalyst contains a quantity of palladium ranging from 0.01 to 5% by weight and a quantity of platinum ranging from 0.01 to 1% by weight, with an atomic ratio platinum/palladium ranging from 0.1/99.9 to 50/50.

22. The process according to claim 21, wherein the catalyst contains a quantity of palladium ranging from 0.2 to 3% by weight and a quantity of platinum ranging from 0.05 to 0.5% by weight, with an atomic ratio platinum/palladium ranging from 1/99 to 30/70.

23. The process according to claim 1, wherein the catalyst is prepared by dispersing the active components on an inert carrier by means of precipitation and/or impregnation.

24. The process according to claim 23, wherein the carrier is selected from activated carbon, activated carbon functionalized with sulfonic groups, silica, alumina, silica-alumina and zeolites.

25. The process according to claim 24, wherein the carrier is an activated carbon with a low ash content and a surface area higher than 100 m²/g.

26. The process according to claim 25, wherein the activated carbon has a surface area higher than 300 m²/g.

27. The process according to claim 26, wherein the activated carbon has a surface area higher than 600 m²/g.

28. The process according to claim 1, wherein the halogenated promoter is selected from substances capable of generating halogen ions in the reaction solvent.

29. The process according to claim 28, wherein the halogenated promoter is selected from substances capable of generating bromide ions such as hydrobromic acid and its salts soluble in the reaction medium such as alkaline bromides, ammonium bromide or sodium bromate.

30. The process according to claim 29, wherein the compound is hydrobromic acid, sodium bromide or potassium bromide.

31. The process according to claim 1, wherein the concentration of halogenated promoter ranges from 0.1 to 50 mg per kg of reaction solvent.

32. The process according to claim 31, wherein the concentration of halogenated promoter ranges from 1 to 10 mg per kg of reaction solvent.

33. The process according to claim 1, wherein the acid promoter is selected from substances capable of generating H⁺ hydrogen ions in the reaction solvent.

34. The process according to claim 33, wherein the acid promoter is selected from inorganic acids such as sulfuric, phosphoric, nitric acid or from organic acids such as sulfonic acids.

35. The process according to claim 34, wherein the acid promoter is sulfuric acid or phosphoric acid.

36. The process according to claim 1, wherein the concentration of acid promoter ranges from 20 to 1000 mg per kg of reaction solvent.

37. The process according to claim 36, wherein the concentration of acid promoter ranges from 50 to 500 mg per kg of reaction solvent.

38. The process according to claim 1, wherein the catalyst is used at a concentration ranging from 0.1 to 10% by weight with respect to the reaction solvent.

39. The process according to claim 38, wherein the catalyst is used at a concentration ranging from 0.3 to 3% by weight with respect to the reaction solvent.

40. The process according to claim 1, wherein the reaction is carried out at a temperature ranging from −5 to 90° C.

41. The process according to claim 40, wherein the temperature ranges from 2 to 50° C.

42. The process according to claim 1, wherein the reaction is carried out at a total pressure higher than atmospheric pressure.

43. The process according to claim 42, wherein the total pressure ranges from 30 to 300 bars.

44. The process according to claim 1, wherein the molar ratio hydrogen/oxygen in the feeding ranges from 1/1 to 1/100.

45. The process according to claim 44, wherein the molar ratio hydrogen/oxygen in the feeding ranges from 1/2 to 1/15.

46. The process according to claim 1, wherein the reaction is carried out in the presence of an inert gas selected from nitrogen, helium, argon.

47. The process according to claim 46, wherein the inert gas is nitrogen.

48. The process according to claim 1, wherein the concentration of hydrogen in the gaseous phase in contact with the reaction solvent is maintained at a value lower than 4.5% molar.

49. The process according to claim 1, wherein the reaction is carried out using air as oxygen source.

50. The process according to claim 1, wherein the reaction is carried out batchwise or in continuous.

51. The process according to claim 1, wherein the solution of hydrogen peroxide is used directly in an oxidation process of a substrate selected from olefins, aromatic hydrocarbons, ammonia and carbonyl compounds, using titanium silicalite as catalyst.
